(19) United States
(12) Patent Application Publication
(10) Pub. No.: US 2008/0020254 A1
(43) Pub. Date: Jan. 24, 2008

(54) POLYMER ELECTROLYTE MEMBRANE HAVING IMPROVED DIMENSIONAL STABILITY

(75) Inventors: Ramandeep Mehmi, Livermore, CA (US); David Olmeijer, San Francisco, CA (US); Christopher G. Castledine, Mountain View, CA (US); David Strait, Mountain View, CA (US); Russell Barton, New Westminster, CA (US)

Correspondence Address: MORGAN, LEWIS & BOCKIUS, LLP, ONE MARKET SPEAR STREET TOWER, SAN FRANCISCO, CA, 94105, US

(73) Assignee: Polyfuel, Inc., Mountain View, CA (US)

(21) Appl. No.: 11/782,551

(22) Filed: Jul. 24, 2007

Related U.S. Application Data
(63) Continuation of application No. 11/445,629, filed on Jun. 2, 2006.
(60) Provisional application No. 60/687,408, filed on Jun. 2, 2005.
(60) Provisional application No. 60/833,177, filed on Jul. 24, 2006.

(51) Int. Cl. H01M 8/10

(52) U.S. Cl. 429/30

(57) ABSTRACT

The invention provides dimensionally stable polymer electrolyte membranes (PEMs) that can be used to fabricate catalyst coated membranes (CCMs) and membrane electrode assemblies (MEAs) that are useful in fuel cells.

### CROSS-REFERENCE TO RELATED APPLICATION

This application is continuation-in-part application of U.S. patent application Ser. No. 11/445,629, filed Jun. 2, 2006, which claims priority to U.S. Provisional Application No. 60/687,408 filed Jun. 2, 2005; and application also claims the benefit of U.S. Provisional Application No. 60/833,177 filed Jul. 24, 2006, under 35 U.S.C. 119(e) each of which is hereby incorporated by reference in its entirety.

### FIELD OF THE INVENTION

Polymer electrolyte membranes having improved dimensional stability, methods of making such membranes and fuel cells containing them.

### BACKGROUND OF THE INVENTION

Fuel cells are promising power sources for portable electronic devices, electric vehicles, and other applications due mainly to their non-polluting nature. Of various fuel cell systems, polymer electrolyte membrane based fuel cells such as direct methanol fuel cells (DMFCs) and hydrogen fuel cell, have attracted significant interest because of their high power density and energy conversion efficiency. The “heart” of such fuel cells is the polymer electrolyte membrane (PEM) The based fuel cell is the so called “membrane-electrode assembly” (MEA), Generally the PEM has catalyst layers disposed on the opposite surfaces of the PEM to form a catalyst coated membrane (CCM).

Proton-conducting membranes for DMFCs are known. Examples include Nafion® from the E.I. Dupont De Nemours and Company or analogous products from Dow Chemical. These perfluorinated hydrocarbon sulfonate ionomer products, however, have serious limitations when used in high temperature fuel cell applications. Nafion® loses conductivity when the operation temperature of the fuel cell is over 80° C. Moreover, Nafion® has a very high methanol crossover rate, which impedes its applications in DMFCs.

A good membrane for fuel cell operations requires balancing various properties of the membrane. Such properties included proton conductivity, fuel-resistance, chemical stability and fuel crossover, especially for high temperature applications, fast start up of DMFCs, and durability. In addition, it is important for the membrane to retain its dimensional stability over the fuel operational temperature range. Conventional PEMs swell isotropically when exposed to fuels such as methanol. Such dimensional changes may cause failure of the fuel cell through failure of the PEM catalyst interface, failure of a sealing function, or through membrane movement within the fuel cell leading to aberrant flow distribution or other problems. The lack of dimensional stability can also lead to poor response of the fuel cell if the PEM is allowed to dry out because of lack of fuel. The in-plane dimensionally stability of the membrane is therefore important in forming PEMs used in fuel cells.

### SUMMARY OF THE INVENTION

Certain mechanical processing can be used to convert a PEM into one that has dimensionally stability in the membrane plane. When exposed to water, methanol, a mixture of water and methanol as well as other solvents, such membranes anisotropically swell in the direction perpendicular to the membrane plane as compared to at least one direction in the membrane plane. This minimizes the in plane swelling of the PEM during fuel cell operation.

The methods of making a PEM having in-plane dimensional stability can use (1) an isotropically swollen PEM or (2) a dried PEM. In each case, the membrane is subjected to strain in at least one direction in the membrane plane.

The strain can be produced by physically stretching swollen membrane before or during the drying of the membrane. Strain can also be applied by stretching a membrane after it is dried.

The membrane can be stretched in the X^{M}, Y^{M} plane in one or more directions by use of tenter machine(s) that pull the membrane in the X^{M} and/or Y^{M} directions, either sequentially or simultaneously, after casting. Stretching can also be produced by tension rollers in combination with nip rollers.

Alternatively, the swollen membrane can be physically restrained and then dried. In this case the tendency of the membrane to shrink in plane during the drying process produces the strain. The restraint can be produced by: (1) restraining one or more opposing edges of the membrane; (2) forming the membrane on a support to which the membrane adheres during drying; or (3) hot pressing the membrane.

One or more dimensional stability vectors in the X^{M}, Y^{M} plane of the PEM define the direction of dimensional stability. Such vectors are generally parallel to the direction(s) in which the membrane is stretched or restrained.

Two or more dimensionally stabilized PEMs can be combined to form a composite PEM. In some embodiments, each PEM has a single dimensional stability vector in the X^{M} Y^{M} plane. In such cases, the PEMs may be oriented in the composite PEM so that dimensional stability vectors in the first and second PEMs in the composite are aligned (parallel) or not aligned. In the later case it is preferred that the layers be oriented so that the dimensional stability vectors are perpendicular if projected onto a plane.

The dimensionally stable PEM can be used to fabricate catalyst coated polymer electrolyte membranes (CCMs) and membrane electrode assemblies (MEAs) that find particular utility in hydrogen fuel cells and direct methanol fuel cells. Such fuel cells can be used in electronic devices, both portable and fixed, power supplies including auxiliary power units (APU's), residential power supplies, backup power supplies and as locomotive power for vehicles such as automobiles, aircraft and marine vessels and APU's associated therewith.

### BRIEF DESCRIPTION OF THE DRAWING

FIG. 1 defines the dimensions of a typical PEM. The width of a membrane is measured in the X^{M} dimension. If the sheet is long, as in a web process, X^{M} will equal the width of a roll of the sheet. The length of the sheet is measured in the Y^{M} dimension. The thickness of the sheet is measured in the Z^{M} dimension.

FIG. 2 depicts the hot pressing of a swollen membrane with perforated stainless steel plates to form a PEM with improved dimensional stability.

FIG. 3 depicts the relationship between membrane water content and the Tg of the membrane.

FIG. 4 depicts a devise for stretching a continuous PEM web containing a region containing pull rollers and a region containing a tenter.

FIG. 5 depicts a devise to restrain opposing edges of a membrane.

FIG. 6 depicts a device for radially restraining and/or stretching a PEM.

FIGS. 7A, 7B and 7C depict various embodiments of composite PEMs.

### DETAILED DESCRIPTION OF THE INVENTION

Dimensionally stable PEMs are made by mechanically processing a PEM to convert it into a PEM that has dimensionally stability in the membrane plane. Such membranes anisotropically swell in the direction perpendicular to the membrane plane as compared to at least one direction in the membrane plane.

The methods of making a PEM having in-plane dimensional stability can use (1) an isotropically swollen PEM or (2) a dried PEM. In each case, the membrane is subjected to strain in at least one direction in the membrane plane.

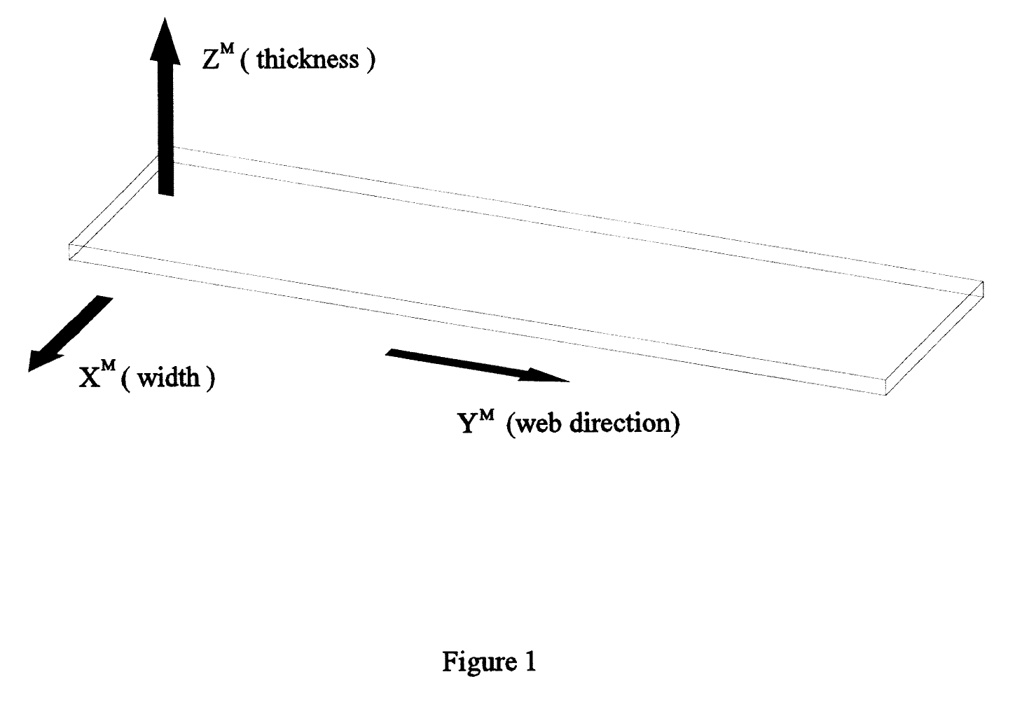

The dimensions of a PEM are set forth in FIG. 1 where X^{M} and Y^{M} define the plane of the PEM and Z^{M} defines the dimension perpendicular to the X^{M}, Y^{M} plane. When a membrane web is used, Y^{M} defines the dimension along the length of the web and X^{M} defines the dimension along the width of the web.

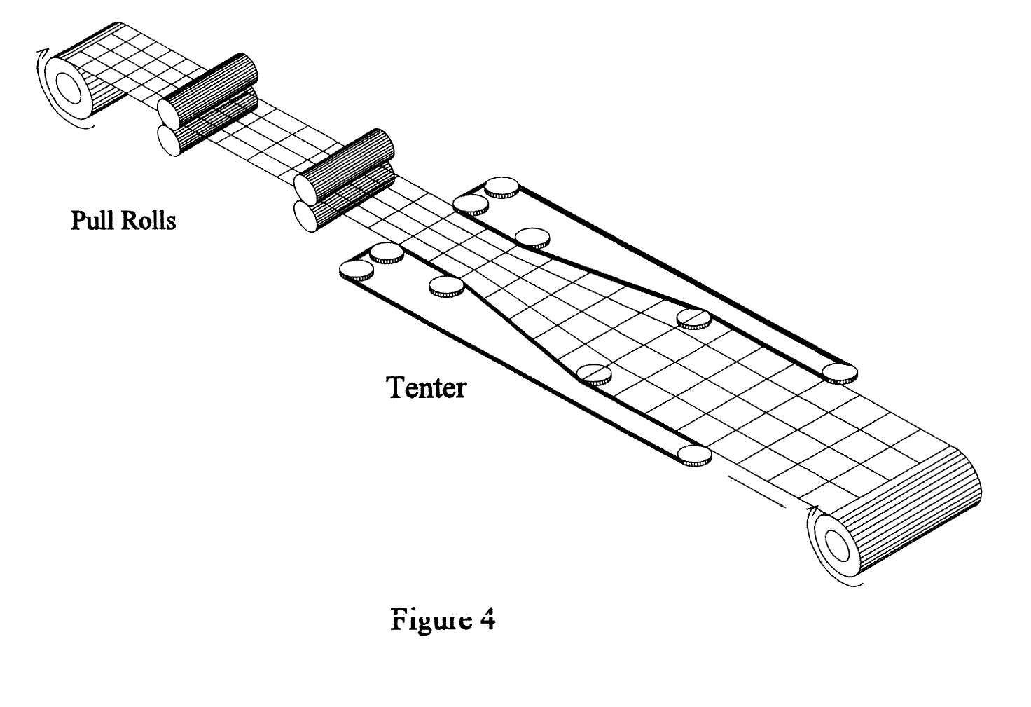

The strain can be produced by physically stretching the membrane before or during the drying of the membrane. A devise for stretching membrane web is shown in FIG. 4. The pull rolls in FIG. 4 stretch the membrane lengthwise in the Y^{m} dimension. The tenter section of the devise stretches the membrane across its width X^{M}. In this case the strain is produced in substantially perpendicular directions in the membrane's X^{M}, Y^{M} plane. Alternatively, one of the pull rolls or tenter can be used to stretch the membrane in the X^{M} or Y^{M} dimension. The membrane is dried during or after the stretching. The stretching and drying of the membrane in for example the X^{M} dimension results in a PEM that does not significantly swell in that dimension as compared to the Z^{M} dimension. When stretched in the X^{M} and Y^{M} dimension and dried, the PEM does not significantly swell in either the X^{M} or Y^{M} dimension as compared to the Z^{M} dimension.

Alternatively, the swollen membrane can be physically restrained and then dried. In this case the tendency of the membrane to shrink in plane during the drying process produces the strain. The restraint can be produced by: (1) restraining one or more opposing edges of the membrane; (2) forming the membrane on a support to which the membrane adheres during drying; or (3) hot pressing the membrane.

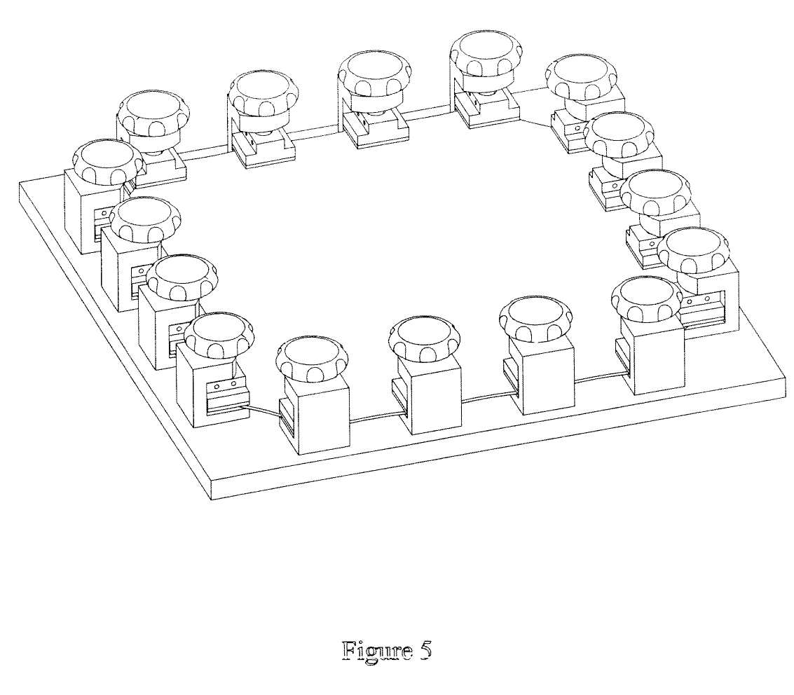

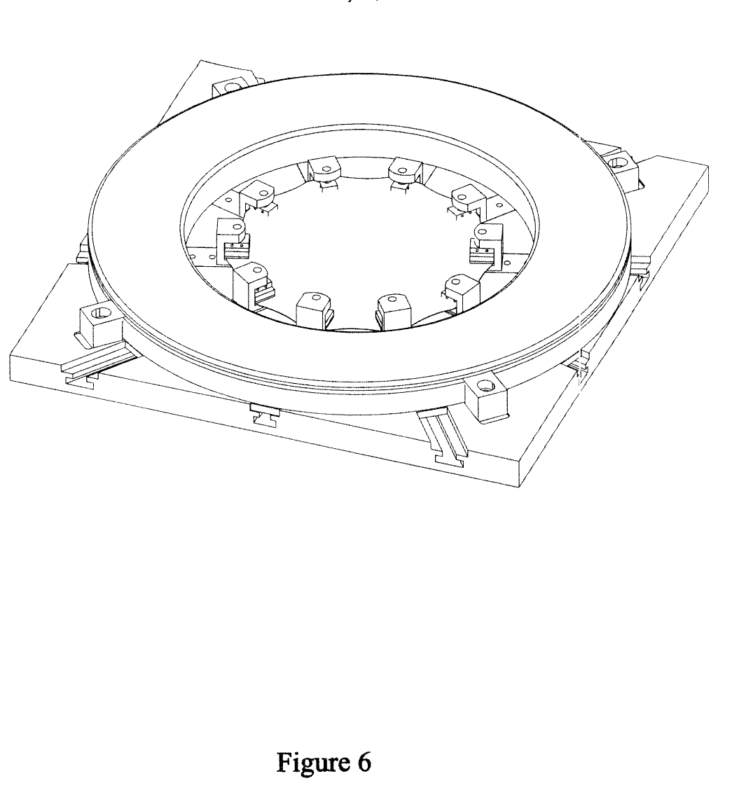

Devises such as those set forth in FIG. 5 or FIG. 6 can be used to physically restrain the membrane. In FIG. 5, a square membrane is restrained along all four edges and dried. This PEM does not significantly swell in either the X^{M} or Y^{M} dimension as compared to the Z^{M} dimension. The devise in FIG. 6 contains a plurality restraining members radially positioned about a central point. Pairs of the restraining members can be positioned opposite to each other. In FIG. 6, four pairs of opposing restraining members are radially positioned 45 degrees form the adjacent restraining pair. The devise of FIG. 4 can be used to restrain the membrane during drying and/or stretch it in one or more directions.

Restraint can also be imposed by casting the membrane on a support and allowing the membrane to dry. The support is chosen so that it will be sufficiently adherent to the cast membrane material so that it restrains the membrane from substantial shrinking during the drying process. Such supports are preferably flexible to facilitate removal of the dried membrane from the support and have a thickness of between 1 mil and 10 mil. Examples of membrane supports include polyethylene teraphthalate (PET), silicon rubber and others know to those skilled in the art.

The swollen PEM can also be hot pressed. The PEM has first and second opposing planar surfaces that are hot pressed with heated perforated members to restrain the PEM from shrinking in plane during the drying of the membrane. In the hot pressing, at least the first surface of the swollen membrane is contacted with a first perforated member having first and second faces. The first face is in contact with all or part of the first surface of the membrane, while the second face of the perforated member and/or its perforations are optionally in contact with an absorbent material. The PEM so formed has unique in-plane dimensional stability as demonstrated by its anisotropic swelling when exposed to water, methanol or a mixture of both.

The method can also include the use of a second perforated member having first and second faces, where the first face is contacted with the second surface of the membrane. The second face of the perforated member and/or its perforations can optionally be in contact with an adsorbent material.

In some embodiments, the perforated member is a perforated cylinder and the hot pressing is of a continuous web of swollen membrane.

The hot pressing is carried out at a temperature above the Tg of the swollen membrane and less than the Tg of the membrane when dried. The hot pressing is carried out at a pressure of between 10 and 50 kg/cm2. After hot pressing, the membrane is cooled, preferably at a rate of at least 15 C/second.

The anisotropic PEM contains islands on the surfaces treated with the perforated member. These islands are in a predetermined pattern that is defined by the perforations in the hot press member. These islands provide the additional advantage of increasing the surface area of the PEM. This can result in enhanced bonding of the catalyst layer and an increase in the current produced by the CCM so produced.

The invention also includes a hot-press (discrete and continuous). Hot presses have previously been used to anneal PEMs. Generally, these devices contain flat solid plates that are used to press the PEM. In the present invention, these plates can be perforated for use in making anisotropic PEMs. Alternatively, perforated plates can be added to the hot press by affixing them to the solid plates. In some instances, an absorbent material may be placed between the solid plates and the perforated plates to facilitate the drying of the membrane. During hot pressing the perforations allow liquid or gas to escape from the membrane. The perforated plate may be used in combination with a wicking material to facilitate liquid or gas transport. A preferred absorbing material is a lint free cloth such as TX409 from TexWipe, Mahwan, N.J.

The perforations in the plates are generally circular having a diameter from 125 to 200 microns and more preferably between about 150 and 180 microns. The perforations are placed in a geometric or repetitive pattern, for example, repetitive hexagons. The size and number of perforations are chosen so that approximately 15-50%, more preferably 25-35% and most preferably about 30% of the surface area of the plate is perforated. Perforated plates useful in practicing the invention can be obtained from McMaster-Carr®, Atlanta, Ga. and include Part Nos. 92315T101, 9255T581, 9255T451, and 9255T151.

When using one or more perforated plates, the PEMs cell so formed contains islands on the treated surfaces. These islands conform generally to the dimensions of the perforations and are positioned in conformity with the pattern of perforations on the pressing plate. These islands have a height of approximately one micron or less. They typically have a height of approximately one micron or less.

As used herein, a “dimensional stability vector” is a vector in the X^{M}, Y^{M} plane of a PEM that defines a direction of dimensional stability. Such vectors are generally parallel to the direction(s) in which the membrane is stretched or restrained.

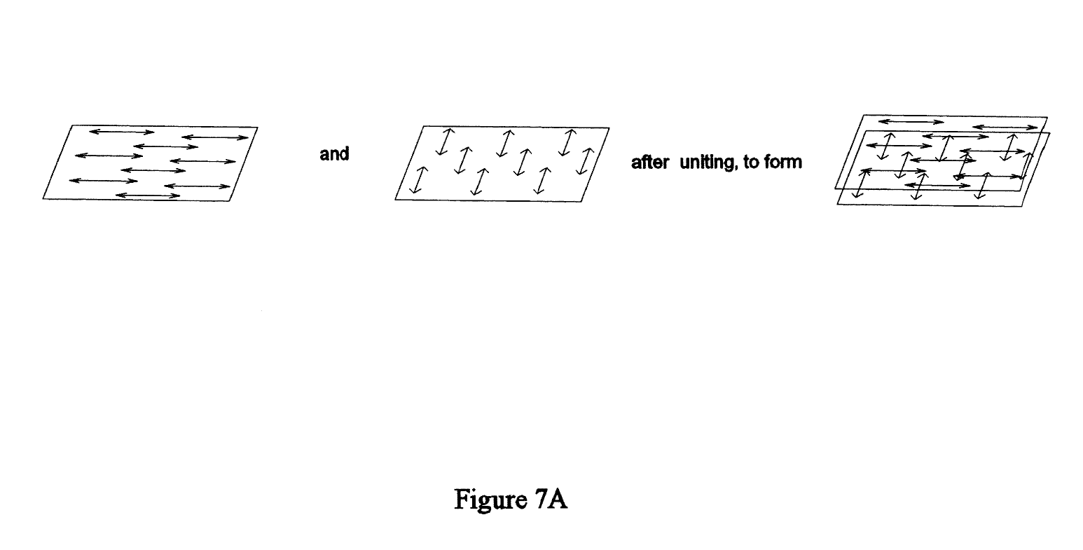

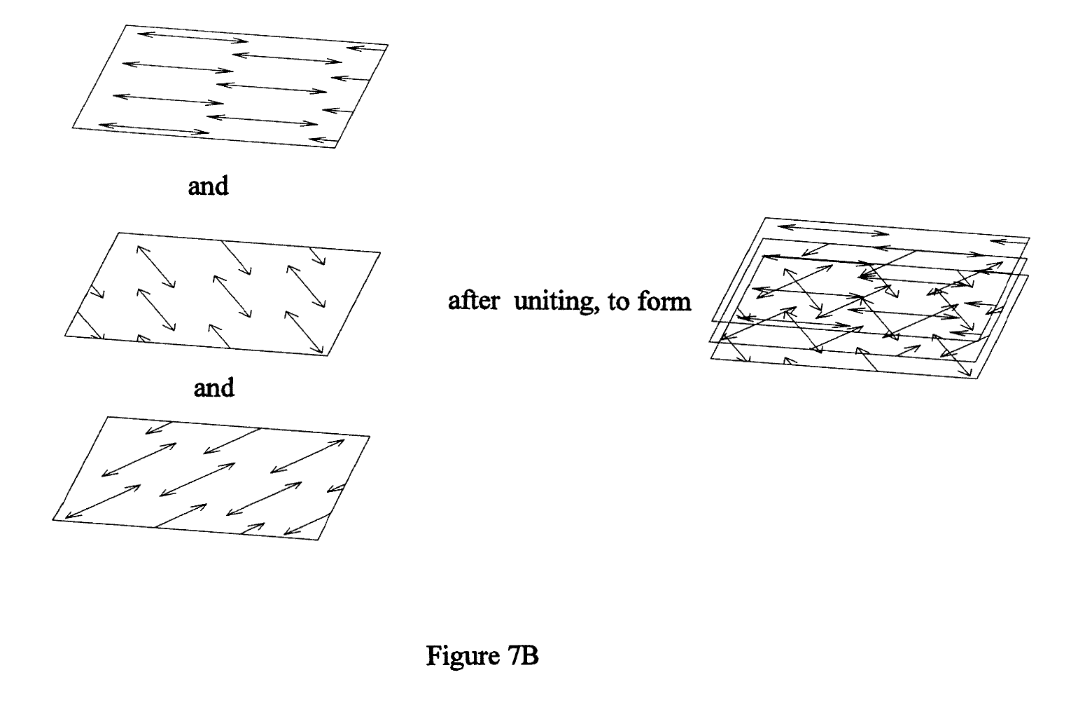

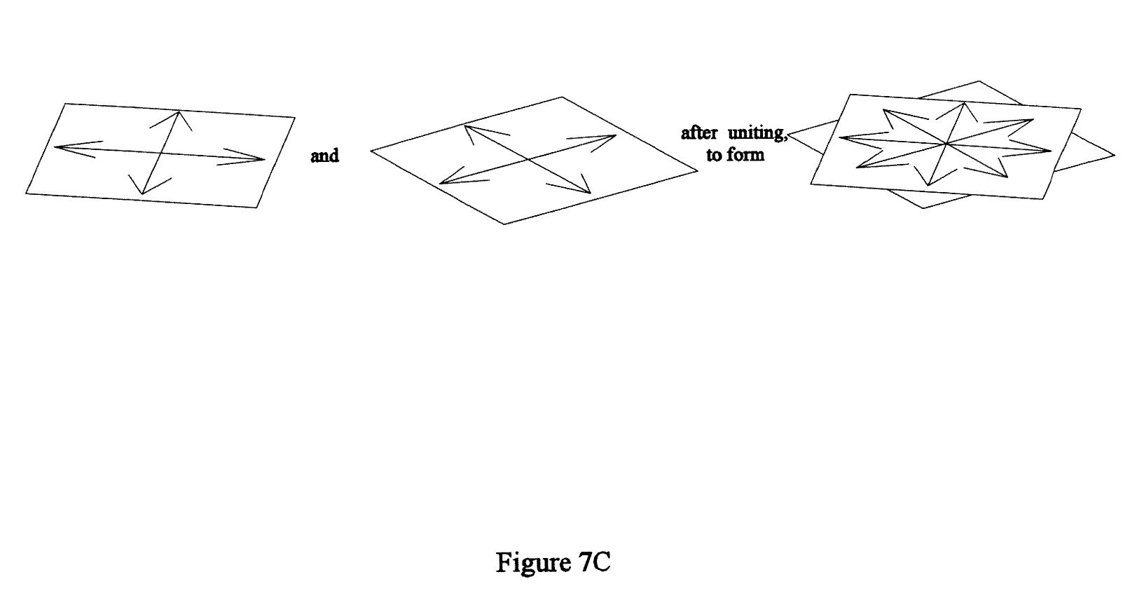

Two or more dimensionally stabilized PEMs can be combined to form a composite PEM. In some embodiments, each PEM has a dimensional stability in one direction. In such cases, the PEMs may be oriented in the composite PEM so that dimensional stability vectors in the first and second PEMs in the composite are aligned (parallel) or not aligned. In the later case it is preferred that the layers be oriented so that the dimensional stability vectors are perpendicular if projected onto a plane. See FIG. 7A. In FIG. 7B, three PEMs which are stabilized in a single direction are oriented so that the dimensional stability vectors are at 60 degrees to each other. The layers are annealed and trimmed, if necessary, to form the composite PEM. These PEMS can be layered in the order shown. Alternatively, PEM (1) can be sandwiched between PEM (2) and PEM (3). In another embodiment, two PEMs each having two perpendicular dimensional stability vectors are used to make the composite PEM in FIG. 7C.

As used herein, “swelling” of a membrane occurs when water or another liquid is absorbed by the membrane causing an increase in volume. As used herein, “anisotropic swelling” refers to the swelling in one dimension which is different from the swelling over the other dimension(s). As used herein, “isotropic swelling” refers to equal or nearly equal swelling in all dimensions.

The swollen membrane in each of the foregoing methods can contain a non-aqueous solvent, water or a combination of both. Alternatively, the swollen membrane can be washed with water prior to treatment to form a hydrated membrane that is substantially free of the casting solvent.

The membrane is usually dried at high temperatures (80° C. to 170° C.) until the membrane changes from clear/transparent to yellow or the desired water content is obtained to form a dried membrane. Exposure to 100° C. for 10-20 minutes typically brings down the water content to <5% by weight. A relatively dry membrane with <5% water by weight can be obtained at 150° C. in less than 4 minutes. It is preferred that the membrane only contain water as a solvent during the drying process. DMAc is not preferred for temperature greater than 80° C., and MeOH and other alcohols do not show adverse effects. However for safety reasons it is preferred that the membrane be washed in water.

A dried membrane is defined as membrane with water content of <5 wt %. This content may depend on the IEC of the polymer used. Normally the higher IEC polymers will retain more water in dry state. The lower IEC polymers will retain less water once dried. It is commonly accepted that this amount of water is the closely held water in the membrane.

Each of the foregoing processes generally results in a thinner PEM which would otherwise be formed. For example, a typical dried PEM that is about 62 microns thick can swell to approximately 80 microns. When dried, the membrane returns to its original thickness. However, when the PEM is treated to form a dimensionally stable membrane, the same membrane which is 80 microns thick when swollen will typically have a thickness of about 45 microns after treatment and drying according to the methods of the invention. The methanol permeability and membrane conductivity (and other properties besides swelling) are essentially unchanged after these processes.

The ion-conductive copolymers can comprise any ion conducting polymer or a blend of ion conducting polymer and non-ionic polymer. The ion-conductive copolymer may be represented by Formula I:
[[—(Ar₁-T-)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula I

wherein Ar₁, Ar₂, Ar₃ and Ar₄ are independently the same or different aromatic moieties, where at least one of Ar1 comprises an ion conducting group and where at least one of Ar₂ comprises an ion-conducting group;

T, U, V and W are linking moieties;

X is independently —O— or —S—;

i and j are independently integers greater than 1;

a, b, c, and d are mole fractions wherein the sum of a, b, c and d is 1; a or b is greater than zero or a and b are greater than zero; and at least one of c and d are greater than 0; and

m, n, o, and p are integers indicating the number of different oligomers or monomers in the copolymer.

The preferred values of a, b, c, and d, i and j as well as m, n, o, and p are set forth below.

The ion conducting copolymer may also be represented by Formula II:
[[—(Ar₁-T-)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula II

wherein

Ar₁, Ar₂, Ar₃ and Ar₄ are independently phenyl, substituted phenyl, napthyl, terphenyl, aryl nitrile and substituted aryl nitrile;

at least one of Ar1 comprises an ion-conducting group;

at least one of Ar2 comprises an ion-conducting group;

T, U, V and W are independently a bond, —C(O)—,

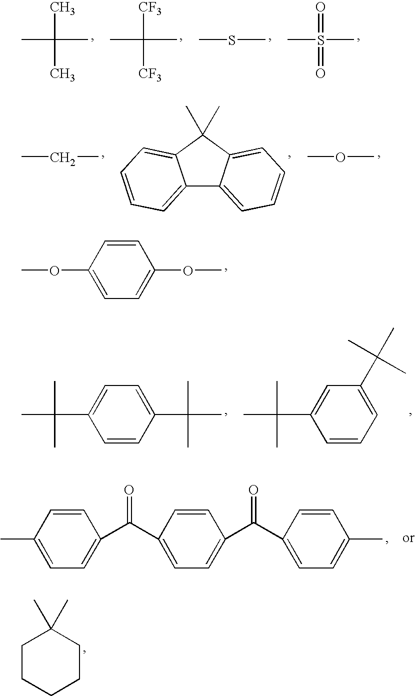

X is independently —O— or —S—;

i and j are independently integers greater than 1; and

a, b, c, and d are mole fractions wherein the sum of a, b, c and d is 1; a or b is greater than zero or a and b are greater than zero; and at least one of c and d are greater than 0; and

m, n, o, and p are integers indicating the number of different oligomers or monomers in the copolymer.

The ion-conductive copolymer can also be represented by Formula III:
[[—(Ar₁-T-)ᵢ—Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/] Formula III

wherein

Ar₁, Ar₂, Ar₃ and Ar₄ are independently phenyl, substituted phenyl, napthyl, terphenyl, aryl nitrile and substituted aryl nitrile;

where T, U, V and W are independently a bond O, S, C(O), S(O₂), alkyl, branched alkyl, fluoroalkyl, branched fluoroalkyl, cycloalkyl, aryl, substituted aryl or heterocycle;

X is independently —O— or —S—;

i and j are independently integers greater than 1;

a, b, c, and d are mole fractions wherein the sum of a, b, c and d is 1; a or b is greater than zero or a and b are greater than zero; and at least one of c and d are greater than 0; and

m, n, o, and p are integers indicating the number of different oligomers or monomers in the copolymer.

In each of the forgoing formulas I, II and III [—(Ar₁-T-)ᵢ—Ar₁—]ₐ^{m} is an ion conducting oligomer; (—Ar₂—U—Ar₂—)_{b}ⁿ is an ion conducting monomer; [(—Ar₃—V—)ⱼ—Ar₃]_{c}^{o} is a non-ionic oligomer; and (—Ar₄—W—Ar₄—)_{d}^{p} is a non-ionic monomer. Accordingly, in some cases these formulas are directed to ion-conducting polymers that include ion conducting oligomer(s) in combination at least two of the following: (1) one or more ion conductive monomers, (2) one or more non-ionic monomers and (3) one or more non-ionic oligomers.

In preferred embodiments, i and j are independently from 2 to 12, more preferably from 3 to 8 and most preferably from 4 to 6.

The mole fraction “a” of ion-conducting oligomer in the copolymer is between 0 and 0.9, preferably between 0.1 and 0.9, more preferably between 0.3 and 0.7 and most preferably between 0.3 and 0.5.

The mole fraction “b” of ion conducting monomer in the copolymer is preferably from 0 to 0.5, more preferably from 0.1 to 0.4 and most preferably from 0.1 to 0.3. The sum of a and b is preferably equal to or greater than 0.3 and equal to or less than 0.7, more preferably 0.3 to 0.5.

The mole fraction of “c” of non-ion conductive oligomer is preferably from 0 to 0.3, more preferably from 0.1 to 0.25 and most preferably from 0.01 to 0.15.

The mole fraction “d” of non-ion conducting monomer in the copolymer is preferably from 0 to 0.7, more preferably from 0.2 to 0.5 and most preferably from 0.2 to 0.4.

The indices m, n, o, and p are integers that take into account the use of different monomers and/or oligomers in the same copolymer or among a mixture of copolymers where m is preferably 1, 2 or 3, n is preferably 1 or 2, o is preferably 1 or 2 and p is preferably 1, 2, 3 or 4.

In some embodiments at least two of Ar₂, Ar₃ and Ar₄ are different from each other. In another embodiment Ar₂, Ar₃ and Ar₄ are each different from the other.

In some embodiments, when there is no hydrophobic oligomer, i.e. when c is zero in Formulas I, II, or III: (1) the precursor ion conductive monomer used to make the ion-conducting polymer is not 2,2′ disulfonated 4,4′ dihydroxy biphenyl; (2) the ion conductive polymer does not contain the ion-conducting monomer that is formed using this precursor ion conductive monomer; and/or (3) the ion-conducting polymer is not the polymer made according to Example 3 herein.

Ion conducting copolymers and the monomers used to make them and which are not otherwise identified herein can also be used. Such ion conducting copolymers and monomers include those disclosed in U.S. patent application Ser. No. 09/872,770, filed Jun. 1, 2001, Publication No. US 2002-0127454 A1, published Sep. 12, 2002, entitled “Polymer Composition”; U.S. patent application Ser. No. 10/351,257, filed Jan. 23, 2003, Publication No. US 2003-0219640 A1, published Nov. 27, 2003, entitled “Acid Base Proton Conducting Polymer Blend Membrane”; U.S. patent application Ser. No. 10/438,186, filed May 13, 2003, Publication No. US 2004-0039148 A1, published Feb. 26, 2004, entitled “Sulfonated Copolymer”; U.S. patent application Ser. No. 10/438,299, filed May 13, 2003, entitled “Ion-conductive Block Copolymers,” published Jul. 1, 2004, Publication No. 2004-0126666; U.S. application Ser. No. 10/449,299, filed Feb. 20, 2003, Publication No. US 2003-0208038 A1, published Nov. 6, 2003, entitled “Ion-conductive Copolymer”; U.S. patent application Ser. No. 10/438,299, filed May 13, 2003, Publication No. US 2004-0126666; U.S. patent application Ser. No. 10/987,178, filed Nov. 12, 2004, entitled “Ion-conductive Random Copolymer”, Publication No. 2005-0181256 published Aug. 18, 2005; U.S. patent application Ser. No. 10/987,951, filed Nov. 12, 2004, Publication No. 2005-0234146, published Oct. 20, 2005, entitled “Ion-conductive Copolymers Containing First and Second Hydrophobic Oligomers;” U.S. patent application Ser. No. 10/988,187, filed Nov. 11, 2004, Publication No. 2005-0282919, published Dec. 22, 2005, entitled “Ion-conductive Copolymers Containing One or More Hydrophobic Oligomers”; and U.S. patent application Ser. No. 11/077,994, filed Mar. 11, 2005, Publication No. 2006-004110, published Feb. 23, 2006, each of which are expressly incorporated herein by reference. Other comonomers include those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A 1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Although the copolymers used in the invention have been described in connection with the use of arylene polymers, the ion conducting polymers need not be arylene but rather may be aliphatic or perfluorinated aliphatic backbones containing ion-conducting groups. Examples include recast or extruded Nafion™, Nafion 115™ or Nafion 117™ Ion-conducting groups may be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the present invention.

Formula IV is an example of a preferred random copolymer where n and m are mole fractions, where n is between 0.5 and 0.9 and m is between 0.1 and 0.5. A preferred ratio is where n is 0.7 and m is 0.3.

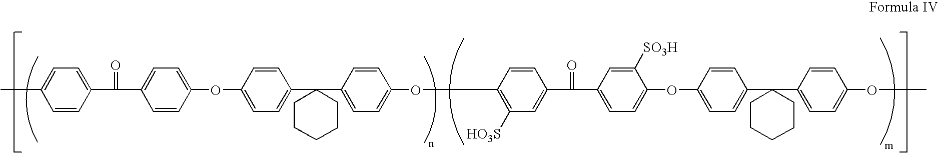

The mole percent of ion-conducting groups when only one ion-conducting group is present is preferably between 30 and 70%, or more preferably between 40 and 60%, and most preferably between 45 and 55%. When more than one conducting group is contained within the ion-conducting monomer, such percentages are multiplied by the total number of ion-conducting groups per monomer. Thus, in the case of a monomer comprising two sulfonic acid groups, the preferred sulfonation is 60 to 140%, more preferably 80 to 120%, and most preferably 90 to 110%. Alternatively, the amount of ion-conducting group can be measured by the ion exchange capacity (IEC). By way of comparison, Nafion®(t typically has a ion exchange capacity of 0.9 meq per gram. In the present invention, it is preferred that the IEC be between 0.9 and 3.0 meq per gram, more preferably between 1.0 and 2.5 meq per gram, and most preferably between 1.6 and 2.2 meq per gram.

The amount of ion-conducting group can be measured by the ion exchange capacity (IEC). By way of comparison, Nafion®t typically has an ion exchange capacity of 0.9 meq per gram. In the present invention, it is preferred that the IEC be between 0.4 and 3.0 meq per gram, more preferably between 0.7 and 2.0 meq per gram, and most preferably between 0.9 and 1.7 meq per gram.

Polymer membranes may be fabricated by solution casting or by hot-melt extrusion of the ion-conductive copolymer. Alternatively, the polymer membrane may be fabricated by solution casting the ion-conducting polymer the blend of the acid and basic polymer.

Polymer membranes may be fabricated by solution casting of the ion-conductive copolymer followed by treatment to produce a dimensionally stable membrane.

When cast into a membrane, it is preferred that the initial membrane thickness be between 0.1 to 10 mils, more preferably between 1 and 6 mils, most preferably between 1.5 and 2.5 mils.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

After the ion-conducting copolymer has been formed into a dimensionally stabilized membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

MEAs comprise the aforementioned dimensionally stable membranes. In some embodiments, CCMs are used to make MEAs. In some embodiments, anode and cathode electrodes are positioned to be in electrical contact with the catalyst layer of the CCM.

The electrodes are in electrical contact with the catalyst layer, either directly or indirectly via a gas diffusion or other conductive layer, so that they are capable of completing an electrical circuit which includes the CCM and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEM's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCMs and MEAs of the invention may also be used in hydrogen fuel cells that are known in the art. Examples include 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

### EXAMPLES

### Example 1

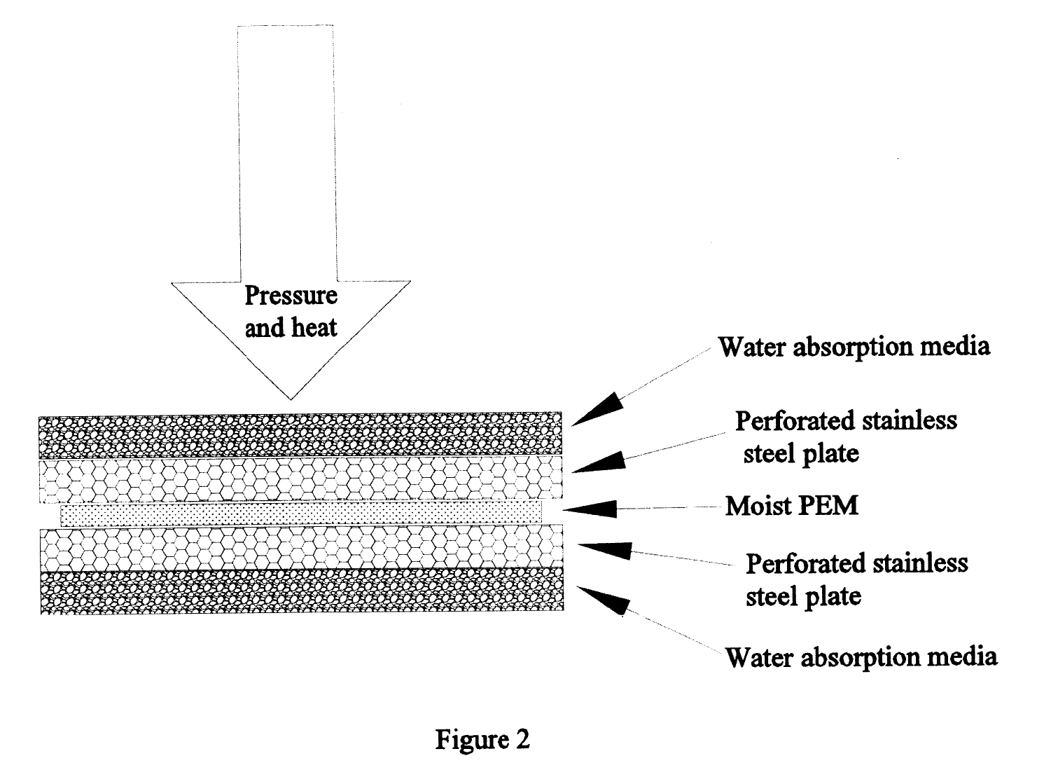

The anisotropic membrane can be made by first swelling a membrane such as the random copolymer in formula IV with methanol or a methanol-water solution, followed by washing with DI (de-ionized water) to remove Methanol. The washed membrane is then hot pressed (150C—above hydrated Tg, 15 kg/cm2 compressive pressure, 45 sec) between two perforated stainless steel sheets that are covered with a cloth-like material, as depicted in FIG. 2. With a significant amount of water present in the membrane, the Tg (Glass Transition Temperature) is lowered and as the membrane loses water while in the hot press, the Tg moves back up to near dry membrane Tg. The stainless steel plates apply uniform pressure and allow water to escape to the cloth which acts like an absorbent. The membrane surfaces make contact with the stainless steel plates, not the cloth.

### Example 2

The anisotropic membrane does not swell in the X and Y plane (surface plane) but does swell in the Z (normal to surface) plane. This anisotropic behavior, swelling principally in the Z direction (thickness), can be achieved for other PEMs from other polymer families particularly polymers with aromatic rings in the backbone structure. The anisotropic membrane exhibits higher conductivities and water uptake along with increased Z/X ratio for swelling, as shown in Table 2 below. The table shows comparison of standard DMFC membrane made from the random copolymer of Formula IV with the anisotropic membrane made from the same polymer.

TABLE 2

| | Standard DMFC (PFI) | Oriented Polymer (OP) |
|---|---|---|
| Property | Membrane | Membrane |
| Swelling in X | 9.2 | 4 |
| Swelling in XY (area) | 19.2 | 8.2 |
| Swelling in Z | 23 | 45.4 |
| Anisotropy Ratio Z/X | ˜2.5 | 11.4 |
| Conductivity (S/cm) | ˜0.032 | 0.051 |
| Water uptake (% wt) | 24 | 45.5 |

### Example 3

A membrane made from random copolymer, formula IV, 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 150° C. with pressure of 10 kg/cm2 for 45 seconds. The resulting membrane swells anisotropically once exposed to solvent/water solutions. In 85 wt % Methanol/water solution the membrane swells <8% in X^{M} and Y^{M} dimension and swells 86% in the Z^{M} dimension.

### Example 4

A membrane made from random copolymer, formula IV, 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 120° C.-170° C. with pressure of 10 kg/cm2-50 kg/cm² for 15-45 seconds. The resulting membrane swells anisotropically once exposed to solvent/water solutions. In 85 wt % Methanol/water solution the membrane swells <8% in X^{M} and Y^{M} dimension and swells 86% in the ZM dimension.

### Example 5

The swelling of the anisotropic membrane is substantially reduced in the X^{M} and Y^{M} plane (surface plane) but does swell in the Z^{M} (normal to surface) plane. This anisotropic behavior, swelling principally in the Z^{M} dimension (thickness), can be achieved for other PEMs from other polymer families particularly polymers with aromatic rings in the backbone structure. The anisotropic membrane exhibits higher conductivities and water uptake along with increased Z^{M}/X^{M} ratio for swelling, as shown in Table 3 below. The table shows comparison of standard DMFC membrane made from the random copolymer of Formula IV with the anisotropic membrane made from the same polymer. Comparison of anisotropic membrane to its parent standard membrane (prepared according to Example 1, 2, 3, 4, and 5) once soaked in 85 wt % methanol (in methanol water solution) at room temperature.

TABLE 3

| | Standard DMFC | |
|---|---|---|
| | (Polyfuel Inc.) | |
| Property | Membrane | Anisotropic Membrane |
| Swelling in X^{M} | 1 | ¼ |
| Swelling in X^{M}Y^{M} (area) | 1 | ¼ |
| Swelling in Z^{M} | 1 | 3 |
| Anisotropy Ratio Z^{M}/X^{M} | 1 | 11.6 |
| Conductivity (S/cm) | 1 | 1 |
| Water content (% volume) | 1 | 1.1 |

### Example 6

A 5 cm×5 cm membrane, made from the random copolymer of formula IV, was first swollen in methanol-water solution (85% methanol by weight) for 16 hours, followed by a DI (de-ionized) water soak for 30 minutes with a change in water every 10 minutes. The washed membrane was then restrained in a tenter frame such as that shown in FIG. 4 and dried (100° C.). The swollen state of the membrane can also be achieved by washing the cast PEM high levels of casting solvent.

### Example 7

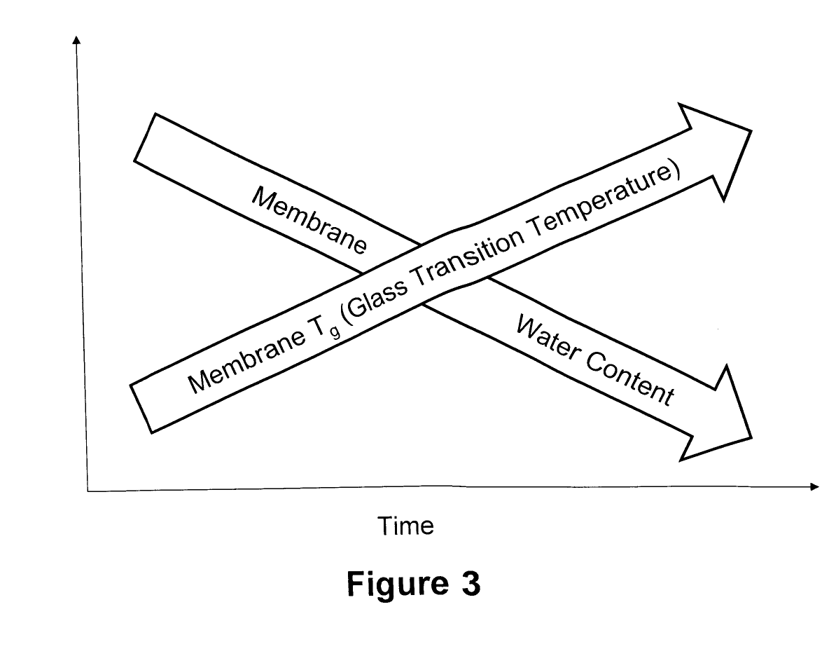

A 5 cm×5 cm membrane, made from the random copolymer of formula IV, was first swollen in methanol-water solution, 85% methanol by weight, for 16 hours, followed by a DI (de-ionized) water soak for 30 minutes with change in water every 10 minutes. The washed membrane is then restrained in a tenter frame and dried at 40° C. to 140° C., shown in FIG. 3. The swollen state of the membrane can also be achieved by washing the cast PEM at high casting solvent levels.

### Example 8

A membrane made from a random copolymer 5 cm×5 cm is swollen in methanol-water solution, 85% methanol by weight, for 16 hours, followed by a DI (de-ionized) water soak for 30 minutes with change in water every 10 minutes. The membrane is then placed between “stack” shown in FIG. 2, and hot pressed at 150° C. with pressure of 10 kg/cm2 for 45 seconds. The resulting membrane swells anisotropically once exposed to solvent/water solutions. In 85 wt % Methanol/water solution the membrane swells <8% in X^{M} and Y^{M} dimension and swells 86% in the Z^{M} dimension.

### Example 9

A membrane made from a random copolymer 5 cm×5 cm is first swollen, in methanol-water solution, 85% methanol by weight, for 16 hours, followed by a DI (de-ionized) water soak for 30 minutes with change in water every 10 minutes. The washed membrane is then restrained in a tenter frame and dried (100° C.) shown in FIG. 3. The swollen state of the membrane can also be achieved by washing the cast PEM at high casting solvent levels.

### Example 10

A polymer of Formula IV is dissolved in N,N-dimethylacetamide, coated onto PET, and dried to a solvent residue of 17% by weight. The 5 cm×5 cm piece of this membrane is then heated in an oven at 10° C. and stretched in the X^{M} dimension to approximately 175% its original length in that dimension. The membrane sample is then washed in water at room temperature for 16 hours and then dried. A dried sample of this membrane is then swelled in 85 wt. % MeOH for 1 hour and then washed with water. The swelling of this membrane is determined to be 2% in the X^{M} dimension, 19% in the Y^{M} dimension and 57% in the Z^{M} dimension.

### Example 11

A polymer of Formula IV was dissolved in N,N-dimethylacetamide, coated onto a PET backing and dried with hot air to a solvent residue of 10-20% by weight. A piece of the resulting membrane was removed from the PET backing and mechanically stretched to about 180% of its original length. The piece was cut in two, arranged in an overlapping manner such that the direction of stretch of the two pieces was at 90° to each other and subjected to heat and pressure (120° C. for 3 min at a pressure of 1000 kg/cm²) such that the pieces were laminated together. The membrane had some residual solvent (DMAc) that helped plastercize the interface to create a bonded/laminated membrane. A washed and dried sample of this membrane was then swelled in 85 wt. % MeOH for 16 hours and then washed with water. The swelling of this membrane was determined to be 12% in the X^{M} dimension, 11% in the Y^{M} dimension and 42% in the Z^{M} dimension.

### Example 12

A polymer of Formula IV was dissolved in N,N-dimethylacetamide, coated onto PET, and dried to a solvent residue of 17% by weight. The 5 cm×5 cm piece of this membrane was then heated in an oven at 100° C. for 5 minutes, removed from the PET backing and stretched in the X^{M} dimension to approximately 175% its original length in that dimension. While still in an oven at 100° C., this sample was stretched in the Y^{M} dimension to approximately 175% its original length in that dimension. The membrane sample was then washed in water at room temperature for 16 hours and then dried. A dried sample of this membrane was then swelled in 85 wt. % MeOH for 1 hour and then washed with water. The swelling of this membrane was determined to be 2% in the X^{M} dimension, 2% in the Y^{M} dimension and 90% in the Z^{M} dimension.

### Example 13

A polymer of Formula IV is dissolved in N,N-dimethylacetamide, coated onto PET, and dried with hot air to a solvent residue of 10-20% by weight. A 15 cm×15 cm piece of this membrane was peeled off the PET film and spliced in the middle of a PET web and transported through an 1 meter oven at 110° C. at 0.2 m/min. Tension was adjusted with a machine having unwind and wind capabilities. The unwind tension was increased to achieve the desired “draw” to achieve stretching of 170% of its original length in that dimension. The membrane was removed from the web, rotated 90° and re-spliced. The membrane was stretched again to 170% of its original length in that dimension. It was removed from the web, washed in water at room temperature for 16 hours and then dried. A dried sample of this membrane was then swelled in 50 wt. % MeOH for 16 hours and then washed with water. The swelling of this membrane was determined to be 9% in the X^{M} dimension, 9% in the Y^{M} dimension and 37% in the Z^{M} dimension. It had a proton conductivity of 0.038 S/cm².

### Example 14

A piece of membrane cast from a polymer of formula IV was thoroughly equilibrated at room temperature and relative humidity then stretched mechanically to about 150% of it's original length only in the X^{M} direction. The sample was then dried and subsequently soaked in 85% methanol overnight then washed in water. The swelling of this membrane in 85% methanol-water was determined to be −5% in the X^{M} dimension (shrinkage in the X^{M} direction), 39% in the Y^{M} dimension and 38% in the Z^{M} dimension. It had a proton conductivity of 0.057 S/cm².

### Example 15

A polymer of Formula IV was dissolved in N,N-dimethylacetamide, coated onto PET, and dried with hot air to a solvent residue of 10-20% by weight. A piece of the resulting membrane was mechanically stretched to about 180% of its original length. The piece was cut in two, arranged in an overlapping manner such that the direction of stretch of the two pieces was at 90° to each other and subjected to heat and pressure (˜1000 kg/cm2, for 3 min. at 120° C.) such that the pieces were laminated together. A washed and dried sample of this membrane was then swelled in 85 wt. % MeOH for 16 hours and then washed with water. The swelling of this membrane was determined to be 12% in the X^{M} dimension, 11% in the Y^{M} dimension and 42% in the Z^{M} dimension.

### Example 16

Nafion (N115) can be stabilized to swell anisotropically via the restrain/dry process in a hot-press. Nafion 115 was swelled in 85% MeOH (wt %) and the hot pressed at 150° C. for 1 minute with 50 kg/cm2 pressure applied. The membrane thus formed shrinks if exposed to temperatures >80° C. However, if the Nafion is hydrated, it swells 1 to 3% in X^{M} or Y^{M} and 54% in Z-M. We found that Nafion must be hot pressed above 120° C. to produce this stability. The difference in X and Y swelling is because the Nafion membrane is slightly uniaxially oriented (possibly a side effect of extruding).

### Example 17

CCMs were hot pressed after swelling in 85% methanol. The CCMs were then washed. The hot pressing was at 150° C. for 3 minutes with 10kg/cm2 pressure. Normally a CCM's active area would swell about 5-6% in both the X and Y directions. The swelled areas of the CCM was maintained during drying, which means that the membrane was restrained at the active area and outside the active area. Given that the area before the hot press and after the hot press was the same, the membrane under the active area is dimensionally stable.

What is claimed is:

1. A method of making a polymer electrolyte membrane (PEM) having in-plane dimensional stability comprising:
(a) providing a PEM having X^{M} and Y^{M} dimensions that define the X^{M}, Y^{M} plane of the PEM and a Z^{M} dimension perpendicular to said X^{M}, Y^{M} plane that defines the thickness of said PEM; and
(b) treating said PEM to create strain in said X^{M}, Y^{M} plane to form a treated PEM;
wherein said treated PEM does not significantly swell in at least one direction in the X^{M}, Y^{M} plane as compared to the Z^{M} dimension when contacted with water and methanol.

2. The method of claim 1 wherein said treating comprises stretching said PEM in one direction.

3. The method of claim 1 wherein said treating comprises stretching said PEM in more than one direction.

4. The method of claim 1 wherein said treating comprises stretching said PEM in two directions which are perpendicular to each other.

5. The method of claim 1 wherein said PEM is a swollen PEM

6. The method of claim 5 wherein said treating comprises stretching said PEM and said method further comprises drying said swollen PEM during or after said stretching.

7. The method of claim 5 wherein said treating comprises drying said PEM while physically restraining said PEM in the X^{M}, Y^{M} plane.

8. The method of claim 7 wherein said restraining is in one direction.

9. The method of claim 7 wherein said restraining is in more than one direction.

10. The method of claim 7 wherein said restraining is in two directions which are perpendicular to each other.

11. The method of claim 1 wherein said PEM is a dried PEM.

12. The method of claim 11 wherein said treating comprises stretching said PEM in the X^{M}, Y^{M} plane.

13. The method of claim 12 wherein said stretching is in one direction.

14. The method of claim 12 wherein said stretching is in more than one direction.

15. The method of claim 12 wherein said stretching is in two directions which are perpendicular to each other.

16. A PEM made according to the method of claim 1.

17. A dimensionally stable PEM having a membrane plane defined by dimensions X^{M} and Y^{M} and a thickness in the Z^{M} dimension perpendicular to said X^{M}, Y^{M} plane, wherein said PEM has improved dimensional stability in said X^{M}, Y^{M} plane.

18. The PEM of claim 17 wherein said PEM swells anisotropically in said Z^{M} dimension as compared to the swelling in said X^{M}, Y^{M} plane.

19. A composite PEM comprising first and second dimensionally stabilized PEMs in direct contact with each other.

20. The composite PEM of claim 19 wherein the dimensional stability of said first PEM is defined by a first vector and the dimensional stability of said second PEMs is defined by a second vector and wherein said first and second vectors are aligned with each other.

21. The composite PEM of claim 19 wherein the dimensional stability of said first PEM is defined by a first vector and the dimensional stability of said second PEMs is defined by a second vector and wherein said first and second vectors are not aligned with each other.

22. A catalyst coated membrane (CCM) comprising the PEM of claim 16, or the composite PEM of claim 19, wherein all or part of at least one opposing surface of said PEM or composite PEM comprises a catalyst layer.

23. A membrane electrode assembly (MEA) comprising the PEM of claim 16 or composite PEM and claim 19.

24. A fuel cell of claim 24 comprising the PEM of claim 16 or composite PEM of claim 19.

25. The fuel cell of claim 21 comprising a hydrogen or methanol fuel cell.

26. An electronic device comprising the fuel cell of claim 24.

27. A power supply comprising the fuel cell of claim 24.

28. An electric motor comprising the fuel cell of claim 24.

29. A vehicle comprising the fuel cell of claim 24.
